(19) United States
(12) Patent Application Publication
(10) Pub. No.: US 2026/0368506 A1
(43) Pub. Date: Nov. 19, 2026

(54) Resource Tuning Through Data-Free Selective Quantization

(71) Applicant: Oracle International Corporation, Redwood City, CA (US)

(72) Inventor: Alex Kogan, Needham, MA (US)

(21) Appl. No.: 19/211,016

(22) Filed: May 16, 2025

(51) Int. Cl. G06N 3/0495; G06N 3/08

(52) U.S. Cl. CPC G06N 3/0495; G06N 3/08

(57) ABSTRACT

Systems and methods for implementing inferencing using a resource-optimized version of a trained large language model are disclosed. Inferencing using a large language model (LLM) may exceed one or more performance constraints, including memory constraints, latency constraints and/or accuracy constraints. Parameters of one or more layers of the model may be selected for quantization at different computational precisions according to the performance constraints and external characteristics of the LLM. Then, at least a portion of parameters may be quantized to convert the parameters from higher precision formats to lower precision formats while preserving other parameters at higher precision formats. This quantization may use a round-to-nearest (RTN) or other linear or non-linear quantizing technique. Then, inferencing tasks may be performed using a model including the quantized parameters that meets performance constraints.

### BACKGROUND

### Field of the Disclosure

This disclosure relates generally to computer hardware and software, and more particularly to systems and methods for implementing machine learning systems.

### Description of the Related Art

With the growth of increasingly large machine learning systems such as large language models (LLMs), quantization has become a necessary tool to manage memory and computing resource demands during inferencing. Complex Post-Training Quantization (PTQ) techniques have evolved to improve inferencing performance, however these techniques use computationally intensive calibration processes to optimize quantization levels before quantization can occur, leading to high computational costs and making the techniques unsuitable for models that are frequently fine-tuned. Meanwhile, simpler, linear quantization techniques lack much or all the calibration needs of non-linear quantization but can produce models that are less accurate than models quantized with other, more advanced techniques.

### SUMMARY

Systems, methods and techniques for inferencing using a resource-optimized variations of trained large language models are disclosed. Inferencing using a source large language model (LLM) may exceed performance constraints such as memory, latency and/or accuracy constraints. Parameters of one or more layers of the source model may be selected for quantization at different computational precision according to the provided performance constraints and external characteristics of the LLM. Then, at least a portion of parameters may be quantized for conversion from higher precision formats to lower precision formats while preserving other parameters in higher precision formats. This quantization may use a round-to-nearest (RTN) or other linear or non-linear quantizing technique. Then, inferencing tasks may be performed using a model including the quantized parameters that meets performance constraints.

### BRIEF DESCRIPTION OF THE DRAWINGS

FIG. 1 is a block diagram illustrating a system implementing a resource-optimized inferencing through selective quantization, according to at least one embodiment.

FIG. 2 is a block diagram illustrating an internal structure of a large language model, according to at least one embodiment.

respect to number of horizontally selected layers preserved at higher precision, according to at least one embodiment.

FIG. 4 is a diagram showing zero shot accuracy of various common tasks with respect to number of vertically selected layers preserved at higher precision, according to at least one embodiment.

FIG. 5 is a diagram showing zero shot accuracy of various common tasks with respect to number of hybrid selection of layers preserved at higher precision, according to at least one embodiment.

FIG. 6 is a diagram showing zero shot accuracy of various common tasks with respect to number different quantization techniques, according to at least one embodiment.

FIG. 7 is a diagram showing a speedup of the Marlin kernel relative to the GEMM operation implemented by PyTorch, according to at least one embodiment.

FIG. 8 is a flowchart illustrating a method for implementing a resource-optimized inferencing through selective quantization, according to at least one embodiment.

FIG. 9 is a flowchart illustrating a method for dividing parameters into encoding groups, according to at least one embodiment.

FIG. 10 is a flowchart illustrating a method for predetermining a preferring selection strategy for selective neural network quantization, according to at least one embodiment.

FIG. 11 is a block diagram illustrating one embodiment of a computing system that is configured to implement ticket-based semaphores, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Quantization has become a valuable tool for serving ever-increasing large language models (LLMs). RTN (Round-to-Nearest) is perhaps the simplest quantization technique and has been used well before LLMs surged to the forefront of machine learning (ML) research. Nevertheless, RTN has been largely dismissed by recent and more advanced quantization techniques that claim superiority over RTN in nearly every aspect of performance. While these newer quantization techniques provide improvements in some areas of performance, they are not without cost as RTN is not only much cheaper to apply, but its token generation throughput can be better than and accuracy can be similar to more advanced alternatives.

LLM inferencing is an expensive process due to large models requiring expensive machines with large amounts of high bandwidth memory (HBM). In fact, some of the largest models available today, such as Llama3.1-405B or DeepSeek V3/R1 with their 671B parameters, do not even fit into one powerful server with 8 Nvidia H100 GPUs with 80 GB HBM each. Furthermore, LLM inference, especially if it involves a generative model such as Llama, is wasteful because token generation is a sequential process, producing new tokens one after another is a serial progression. As such, the computation involved in token generation is comprised of vector by matrix multiplications that do not allow much data to be reused once it is brought from memory to computing units. Consequently, the generation process is known to be memory-bound leaving massive dedicated processing in these systems underutilized.

Over the past few years, quantization has emerged as de-facto the standard way of tackling both aforementioned issues. During a quantization process, model weights (and/or activations) are compressed into lower precision (e.g., from 16 bits down to 4 bits), therefore resulting in a smaller memory footprint for the model. This, in turn, leads to reduced hardware requirements for inference and, arguably, to a more efficient token generation process. Due to its practical importance, quantization of LLMs has been a subject of extensive research. This research has lead to a number of impressive results, with methods like GPTQ, AWQ, SmoothQuant, QQQ and many others, each aiming to produce a highly compressed model that is accurate and fast during inference.

These advanced techniques often dismiss or claim superiority over other simpler, linear quantization methods that has been around well before LLMs came to exist. One such method is RTN or Round-to-Nearest, which involves scaling given model weights and, as its name suggests, rounding the result to a nearest integer. RTN, and similar linear quantization methods, convert weights into a uniformly distributed integer data type without the need for calibration data sets.

A few favorable characteristics help RTN to stand out from other, more advanced quantization techniques, making it a desirable choice for quantizing LLMs. First, unlike most other quantization methods, it is data-free, i.e. it does not require any calibration data nor a corresponding calibration process. As such, RTN can be applied on-the-fly, for example while loading a model, and its application is fast (a few milliseconds or seconds, depending on the size of the model) and low cost. Second, RTN can be applied to a model even on a machine that cannot fit the original (non-quantized) model in its GPU memory. For instance, we can use a server with 4 Nvidia H100 GPUs to load, quantize with RTN and run inference on the Llama3.1-405B model.

At the same time, RTN is often believed to lag behind more advanced quantization techniques in two crucial areas—accuracy and generation latency. However, systems, methods and techniques utilizing RTN for inferencing using a resource-optimized variations of trained large language models are disclosed herein which dispel this established point of view. Results show a recovery rate of RTN, or accuracy across various tasks compared to the baseline non-quantized model, is perfect when a model is quantized to 8 bits, is nearly perfect and on par with other, more sophisticated quantization techniques on extremely large models quantized to 4 bits but falls behind on moderate and small scale models quantized to 4 bits. Therefore, RTN is not only much cheaper to apply, but also its token generation throughput can be better than and accuracy can be similar to more advanced alternatives.

Systems, methods and techniques demonstrate that selective quantization may mitigate disadvantages of linear quantization such as RTN for moderate and small scale models. Where inferencing using a source large language model (LLM) may exceed performance constraints such as memory, latency and/or accuracy constraints, parameters of one or more layers of the source model may be selected for preservation of computational precision according to the provided performance constraints. Then, parameters other than the selected parameters may be quantized for conversion from higher precision formats to lower precision formats while preserving higher precision formats of the selected parameters. This quantization may use a round-to-nearest (RTN) or other linear quantizing technique. Then, inferencing tasks may be performed using a model including the quantized parameters and preserved parameters that meets performance constraints.

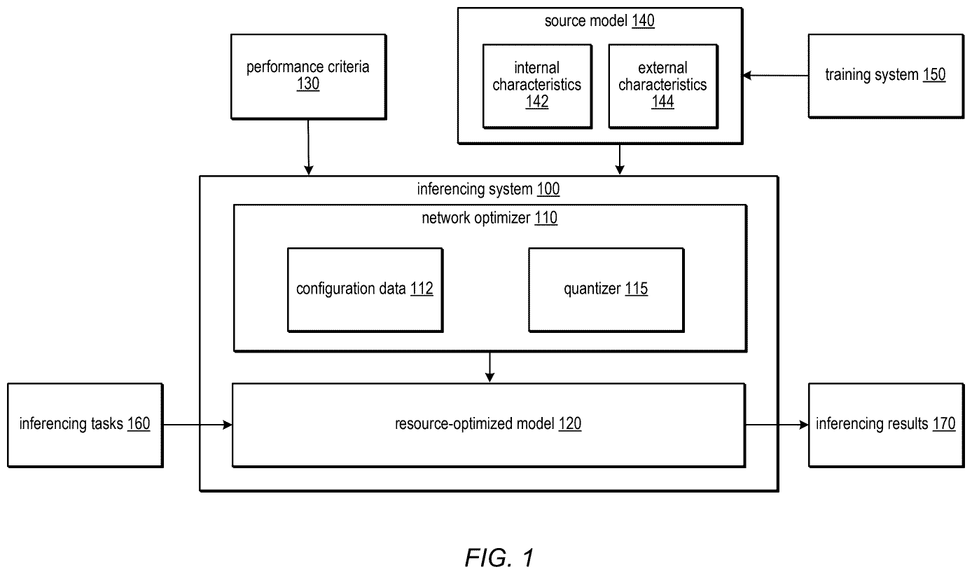

FIG. 1 is a block diagram illustrating a system implementing a resource-optimized inferencing through selective quantization, according to at least one embodiment. In at least one embodiment, an inferencing system 100 may generate a resource-optimized neural network (NN) model 120, such as a large language model (LLM) or other neural network model, that processes inferencing tasks 160 to produce inferencing results 170. In at least one embodiment, inferencing system 100 may employ a source model 140 that may not be directly usable for inferencing according to provided performance criteria 130. The criteria may include, in various embodiments, memory constraints during inferencing, maximum latency constraints, processing constraints, accuracy constraints and so forth. These examples of constraints, however, are not intended to be limiting and other constraints may be envisioned.

In at least one embodiment, source model 140 may include various aspects of structure and functionality that may be categorized as either internal characteristics 142 or external characteristics 144. Internal characteristics 142 pertain to source model inner details such as parameters and connections among neurons within the source network. External characteristics 144 describe elements that influence operation of the model as a black box such as the input data and the environment source model 140 operates in. Examples of internal characteristics 142 include parameters of the model, weight values and biases between connections of neurons, an internal architecture including number of layers, structure of individual layers, number of neurons per layer and so forth, activation functions, loss functions, learning functions and so on. Examples of external characteristics 144 include type of model, hyperparameters used to train a model, data sets used to train a model, resources required to execute the model, and so on. These, however, are merely examples of internal and external model characteristics and are not intended to be limiting.

To generate resource-optimized model 120, inferencing system 100 may employ a network optimizer 110 that includes configuration data 112 and a quantizer 115 to selectively quantize parameters of source model 140 post-training according to external characteristics 144. Configuration data 112 may be generated in various ways; in some embodiments it may be specified along with the source model itself or derived from a model type of source model 140 as part of external characteristics 144 while in other embodiments, configuration data 112 may be generated through benchmarking or other analysis to generate metrics derived from external characteristics 144. These metrics may be used to calculate perplexity on a given set of data to choose a regime that leads to lowest perplexity. By selectively quantizing parameters according to external characteristics 144 of source model 140, network optimizer 110 may avoid computationally intensive processes for generating selections that involve use of internal characteristics, enabling the network optimizer 110 to generate resource-optimized models in the absence of internal characteristics 142 and perform efficiently in embodiments where a training system 150 frequently updates source model 140.

Quantizer 115 may employ a linear quantizer such as an RTN or Round-to-Nearest quantizer, which involves scaling given model weights and rounding the result to a nearest integer. RTN, and similar linear quantization methods, converts weights into uniformly distributed integer data types without need for calibration data sets. Unlike quantization-aware training (QAT) strategies that typically come with a high training cost, post-training quantization (PTQ) offers cheap, accurate and performant methods to reducing the size of models such as LLMs. The majority of PTQ methods require calibration data which they use to find optimal values, i.e., values that reduce a rounding error introduced when decreasing the number of bits representing model weights and/or activations. For instance, AWQ uses calibration data to find salient weights, which it then scales with factors computed to minimize the mean-squared error of quantization. GPTQ uses calibration data to calculate inverse Hessian matrix employed to find quantized weights. The QQQ method uses calibration data twice, once to identify and selectively smooth activation channels that contain outliers and then to calculate the inverse Hessian matrix.

Calibration data-dependent quantization has several drawbacks. First, it might weaken the ability of LLMs to generalize as it introduces the risk of overfitting to the data selected for calibration. Second, it requires a separate process for applying quantization which results in a separate set of quantized model weights. This makes application of quantization more cumbersome. Third, this process, albeit much shorter than model pre-training or even fine-tuning, still requires non-trivial resources, such as hours or even days of GPU time; moreover, it requires at least the number of GPUs with enough high bandwidth memory to load the source model.

### RTN

Round-to-nearest (RTN) quantization is, perhaps, the simplest quantization technique known well before large language models came to exist. RTN is applied on a vector of real values in a floating point format (e.g., FP16 or BFloat16) by dividing each value in the vector by a scaling factor, rounding the result to the nearest integer (hence, the name of this method) and truncating, if necessary, the final integer number so it fits into the target range of values (e.g., [−128, 127] for INT8 or [−8, 7] for INT4). This method is summarized by the following simple formula:

RTN(r)=Int(r/S) (1)
where r is a vector of input values, S is a scaling factor and Int is a function that maps a real value to an integer value through round-to-nearest and truncate operations. We note that we describe a symmetric variant for RTN; an asymmetric variant, more suitable for input values that are not distributed around zero, subtracts an arbitrary integer zero point from the result of the Int function.

A scaling factor maps given real values into a partition in a range of integers, where the size of the range is set by the number of bits in the target precision. In the symmetric formulation of RTN, S is set according to the following formula:

$$S = \frac{2 max ( \vert r \vert )}{{2}^{b} - 1} = \frac{max ( \vert r \vert )}{{2}^{b - 1} - 0.5} \qquad ( 2 )$$

where max(|r|) calculates the maximum absolute value in the given input and b is the target precision bit width.

As described, RTN is oblivious to the size of the input vector r, however, choosing a size for the vector has important practical implications. In the context of large language models, several obvious choices exist. The first is to apply RTN to the entire weights tensor of each linear module in the Transformer stack. This leads to a memory efficient outcome since only one scale factor per tensor is required. However, the resulting quantized model is susceptible to a significant loss of accuracy due to the presence of outliers in the input data which tend to reduce the quantization resolution by skewing the scaling factor. Hence, a more preferred way is to apply RTN channel-wise, i.e., splitting each weights tensor along its channels and producing one scaling factor per channel. The third approach has an even better effect on the accuracy of quantized models and hence is the most common. Specifically, it splits each channel into groups of g values and applies RTN separately to each group. This sub-channel-wise application contains outliers better (now their impact is limited to a group of g numbers rather than the entire channel/tensor), but elevates the memory cost as it requires storing more scaling factors. g is typically set to 2n, with n=7 being seemingly a popular choice. The issue of outliers in the input is far from being unique to RTN, and in fact, is in the heart of most quantization techniques for LLMs; likewise, refining the application of quantization by splitting input values into small groups is a common technique for improving accuracy of quantized models.

RTN exhibits beneficial characteristics over other, more advanced quantization techniques making it a desirable choice for quantizing LLMs. First, unlike most other quantization methods, it is data-free, i.e. it does not require any calibration data nor a corresponding calibration process. As such, RTN can be applied on-the-fly, for example while loading a model, and its application is fast and low cost. Second, RTN can be applied to generate resource-optimized model 120 even on a machine that cannot fit source model 140 in memory. It should be understood, however, that RTN is merely one example of a quantizer that may be employed and other quantizer techniques may be envisioned.

In at least one embodiment, network optimizer 110 may selectively apply quantizer 115 to a subset of parameters of source model 140 according to configuration data 112 and performance criteria 130. In at least one embodiment, two quantization dimensions may be considered by network optimizer 110. First, there is a stack of model layers from which specific layers may be selected, with all their associated weights preserved at a higher precisions. This is referred to herein as horizontal selection. Second, each model layer often implements a similar architecture and consists of linear modules that contain weight parameters. Each of these modules across all model layers may be selected for preservation and this is referred to as vertical selection herein. Further details regarding selection techniques are discussed below.

In at least one embodiment, source model 140 may be trained and/or fine-tuned by training system 150. Upon retraining, inferencing system 100 may update resource-optimized model 120 by selectively applying quantizer 115 without performing calibration steps, as in at least one embodiment quantizer 115 does not require calibration data nor a corresponding calibration process.

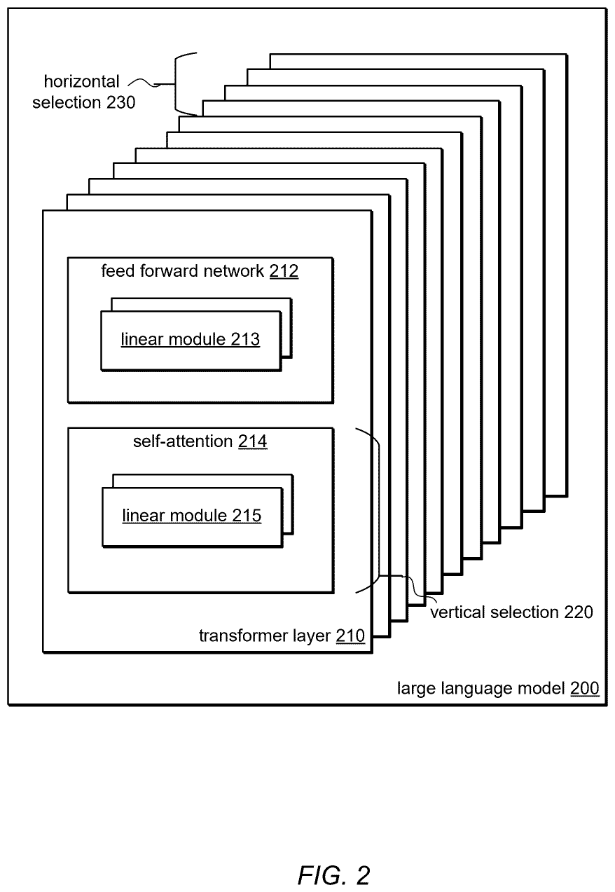

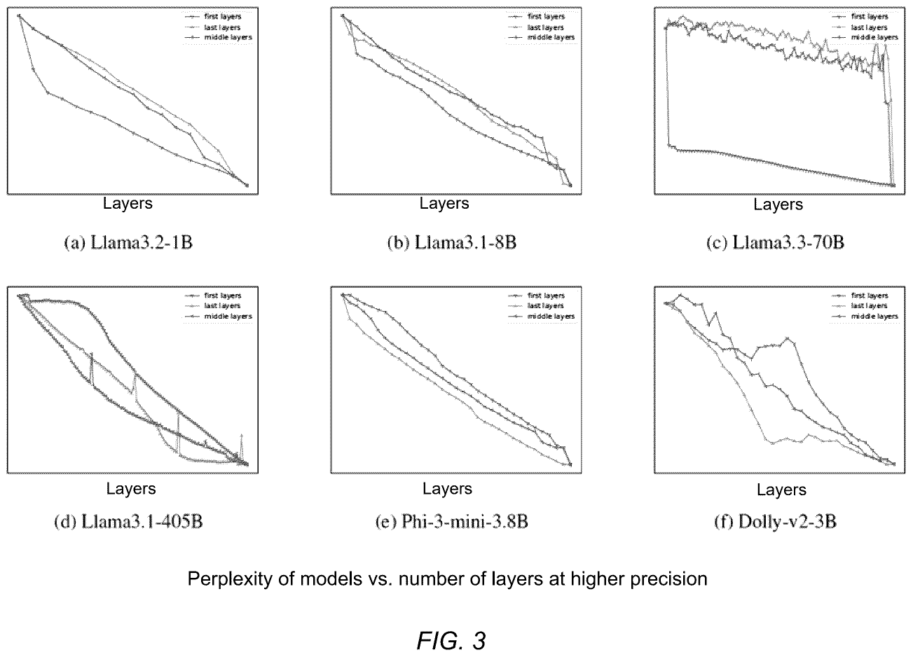

FIG. 2 is a block diagram illustrating an internal structure of a large language model (LLM), according to at least one embodiment. An LLM 200 is a type of artificial intelligence that can understand, generate, and manipulate human language. It's trained on vast amounts of text data, enabling it to produce relevant responses to various prompts. LLMs deep learning, a type of machine learning, to analyze unstructured data and recognize patterns in language. The deep learning of an LLM neural network is typically implemented using many layers of a transformer architecture, where individual transformer layers 210 have a common internal architecture may typically include four linear modules. These include two linear modules 215 of an self-attention component 214 as well as two linear modules 213 of a fully-connected feed-forward network component 212. Tokens may then progress through the transformer layers before being emitted as part of inferencing of LLM 200.

This transformer architecture gives rise to two distinct strategies for selective quantization, a horizontal selection strategy and a vertical selection strategy. Furthermore, these strategies may be combined in various ways, in at least some embodiments.

### Horizontal Selection

In at least one embodiment, horizontal selection involves selecting entire model layers 230 for preservation at higher precision. Three strategies may be considered, first layers, last layers or middle layers of the model stack preserved at higher precision (i.e., quantized to 8 bit) while the rest of the model is quantized into 4 bits.

FIG. 3 is a diagram showing zero shot accuracy of various common tasks, according to at least one embodiment. FIG. 3 shows that the model accuracy, as measured by perplexity, is highly sensitive to the way model layers are selected. While for smaller Llama models, FIG. 3 (a)-(c), the perplexity improves fastest when the first layers are kept in a higher precision, for the largest Llama model, FIG. 3 (d) selecting middle layers for higher precision is beneficial most of the time, and yet for two non-Llama models (FIG. 1e-f) it appears the best strategy is to keep the last layers in higher precision. The result for Llama3.3-70B is especially noteworthy—the perplexity drops substantially after only one layer is kept in 8 bits.

### Vertical Selection

In at least one embodiment, neural network models may implement a large language model (LLM) that includes multiple transformer layers, where each transformer layer may typically include four linear modules. In at least one embodiment, accuracy of resource-optimized models may depends on which linear modules are selected to be preserved in higher precision. Given four linear modules 213 and 215 of each Transformer layer, there are 24 or sixteen ways to make a vertical selection, as shown in 220 of FIG. 2.

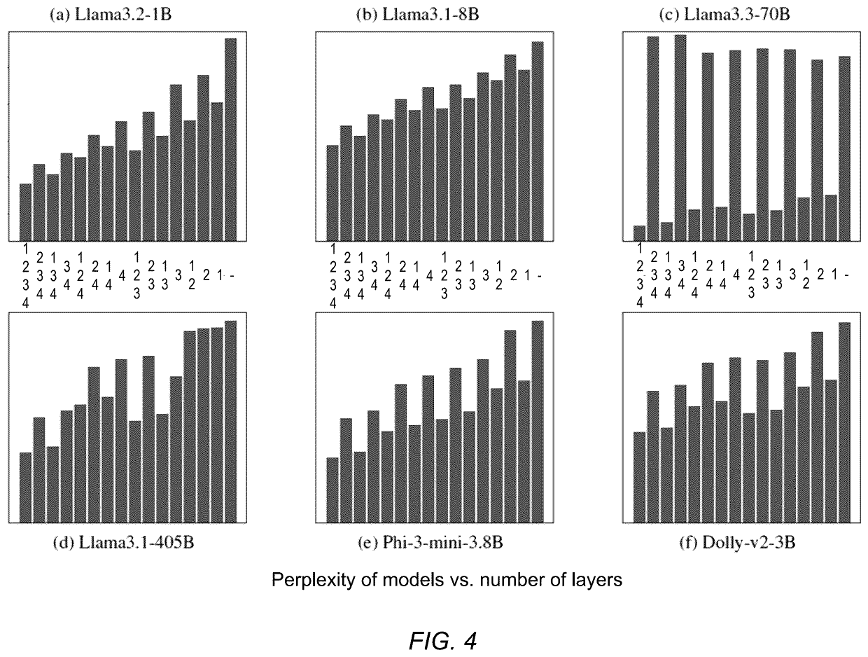

In the following charts, we refer to two modules in an attention component as ‘1’ and ‘2’ and, respectively, to two modules in a fully-connected feed-forward component as ‘3’ and ‘4’. The perplexity results for various models and all possible selection modes can be found in FIG. 4. Overall, the perplexity rises as less modules are selected to be left in higher precision. Notably, however, the perplexity is barely changed when only module ‘2’ (the final projection in the self-attention component) is quantized to 4 bits, comparing to the result when all modules kept in 8 bits. In other words, this experiment suggests that model accuracy is not affected substantially when one specific module is quantized to 4 bits across all layers.

### Hybrid Selection

In at least one embodiment, a combination, or hybrid, of horizontal and vertical selection may be employed. A number of layers may be selected, first layers for all models but Llama3.1-405B and middle layers for Llama3.1-405B, based on the results in FIG. 3 and modules ‘1+3+4’ in those selected layers are quantized to 8 bit, while the rest of the model is quantized into 4 bit. The number of layers selected are either half or a quarter of the total number of layers of each model. Note that when a quarter of the model uses 8 bit precision while the rest uses 4 bit, the model is effectively quantized into 5 bit, on average. Similarly, for the case of half the model, the model is effectively quantized into 6 bit. However, since we also quantize one of the four linear modules into 4 bits, the average precision is lower. Yet, for simplicity sake, we refer to those variants RTN-\tilde{5} and RTN-\tilde{6}, respectively. In addition, for the LLama-3.1 70B model we experiment with a variant in which only modules ‘1+3+4’ of the first layer are quantized to 8 bit; the rest of the layers are quantized to 4 bit. We refer to this variant as RTN-\tilde{4}.

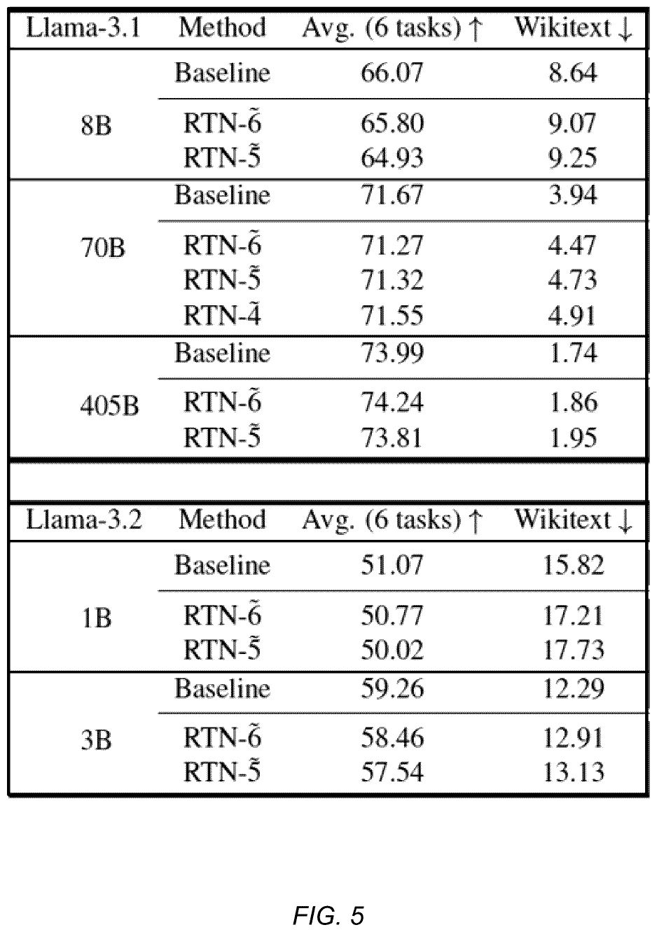

The results for models RTN-\tilde{4}, RTN-\tilde{5} and RTN-\tilde{6} are presented in FIG. 5. As expected, the accuracy of the models increases with the increased precision. In particular, RTN-\tilde{6} is able to recover most accuracy lost by RTN-\tilde{4}. The recovery rate of RTN-\tilde{5} improves over RTN-\tilde{4}, and although it falls slightly below that of RTN-^{~}6, the accuracy of RTN-\tilde{5} matches or exceeds performance of GPTQ and AWQ for all considered models. This suggests that RTN-\tilde{5} is able to strike good tradeoff point between the size of the resulting model and its accuracy.

These results show that selective quantization, in which certain layers of the layer stack of a given model are selected to be quantized to a different precision, may be employed in various embodiments to optimize resource usage and performance of model inferencing while using simpler, linear quantization methods such as RTN.

### Marlin Kernels

Marlin kernels support high-performance mixed-precision GEMM (general matrix multiplication) operations. Such operations allow multiplying 16 bit activations by 4 or 8 bit weights, commonly referred to as W4A16 or W8A16. A common, but inefficient way of implementing them is by dequantizing the weights first and then applying GEMM in 16 bit precision. Marlin hides the overhead of dequantization by effectively overlapping data access latency with floating-point operations involved in dequantization and GEMM calculations. It does so through the combination of various techniques, such as an asynchronous memory access and optimized data layout in memory, Marlin achieves close to optimal 4× improvement over the 16 bit GEMM calculation for batches of up to sixteen to thirty two inputs, which translates to substantial end-to-end inference speedups.

Accuracy of RTN with the target precision of 4 and 8 bits, referred to as RTN-8 and RTN-4 respectively, may be compared to the accuracy of other, more advanced quantization techniques using the vLLM framework v0.6.4 patched to support RTN. One system with 8 Nvidia H100 GPUs with 80 GB GPU memory may be used, except for when a model does not fit into memory (e.g., the original Llama3.1-405B model for two such systems are used). All experiments are run with Python 3.11, PyTorch 2.5.1 and CUDA 12.6.

Llama models of various sizes are used as well as with other open-source models, such as Phi, Dolly and Mistral, in order to validate findings beyond Llama models. The wikitext dataset is used to measure perplexity and common zero shot tasks, such as WinoGrande, ARC, TruthfullQA, CommonSenseQA and PubMedQA, to measure the accuracy of large language models. For all the experiments, the open-source lm_eval toolkit is utilized with its default settings unless specified otherwise. Performance of baseline versions that utilize BFloatl6 or FP16 data format are compared to ones produced with RTN. Also included are results for models quantized with state-of-the-art AWQ and GPTQ quantization methods that use INT4 as their target precision; those models are available on HuggingFace model hub.

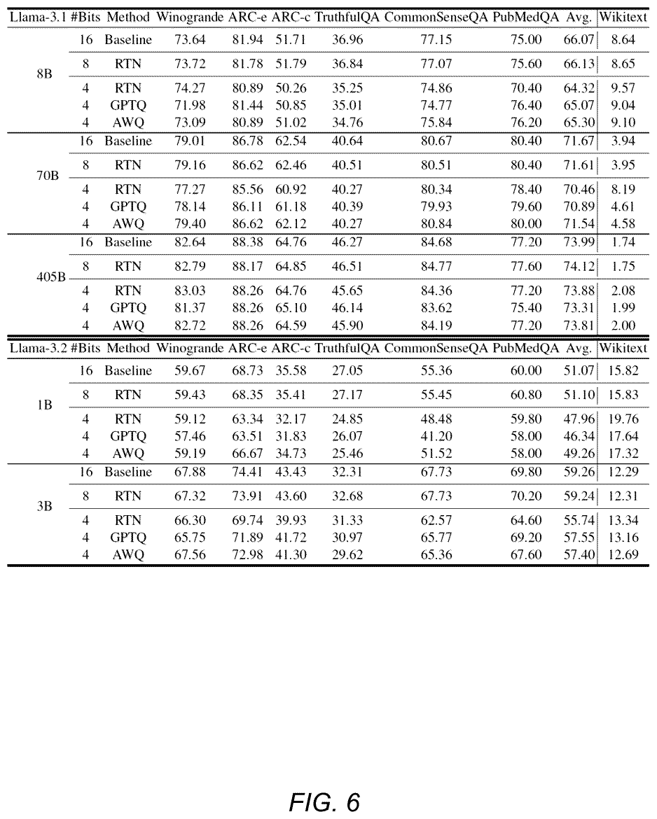

The results for Llama models are presented in FIG. 6. Two important observations may be made: first, RTN-8 achieves full recovery compared to the baseline versions. Second, the recovery rate of RTN-4 falls behind those achieved by other quantization techniques, unless the model is extremely large (e.g., for Llama 3.1 405B, RTN-4 performs on par with all other variants, including the baseline). Those findings support quantizing only a part of the given model to 8 bit (e.g., the first few layers) and keep the rest in 4 bit precision to achieve full accuracy recovery.

Improving Latency with Marlin

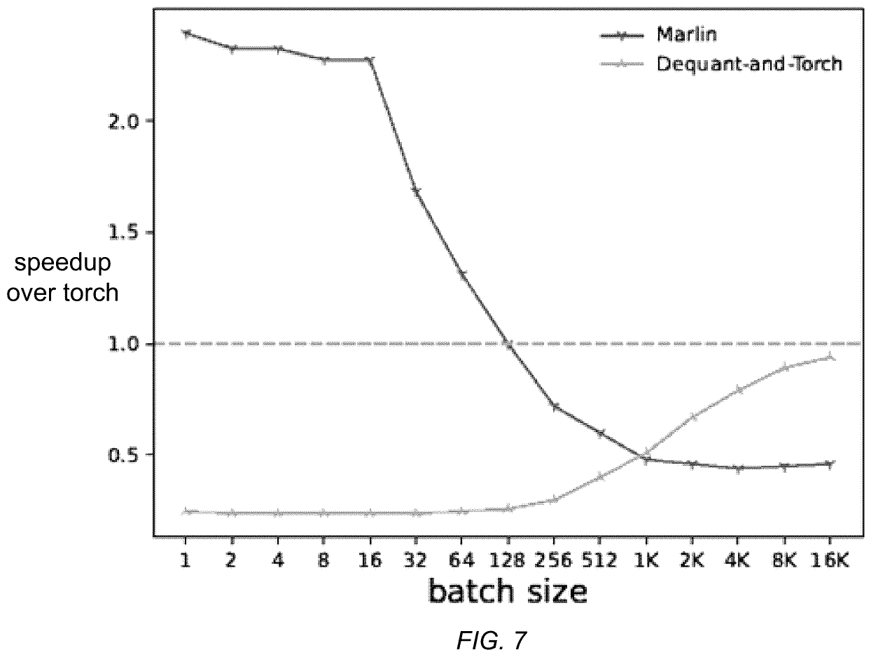

Custom CUDA kernels for RTN may be based on the Marlin project which implements high performance mixed-precision GEMM operations. The Marlin kernel expects a specific interleaved data layout for the tensor representing quantized weights. As a result, data quantized with RTN is reorganized to match that specific layout. This operation takes place once (for each weights tensor), while loading and quantizing data, and does not have any impact on the runtime performance during inference. Being designed specifically for batch sizes of 16-32 tokens, we discover that the Marlin kernels perform poorly when they are invoked with tensors representing activations of a large input dimension. Such tensors are common in realistic workloads since the input dimension is defined by a product of the batch size by the length of (number of tokens in) each input. Hence, when the batch size is low (or even just 1), a long prompt can lead to activations tensor with a large input dimension. The issue is highlighted by the data collected with a built-in benchmark in the Marlin repo2. This benchmark varies the batch size and measures the average latency of running GEMM operations with matrices corresponding to shapes employed by linear modules of a specific model; the results for the LLama3.1-8B model are depicted in FIG. 7 where we show the speedup of the Marlin kernel relative to the GEMM operation implemented by PyTorch; the speedup falls below 1 for batch size over 128 tokens.

In at least one embodiment, this issue may be mitigated by introducing a dual-path approach into the implementation of the forward path for linear module of models quantized with RTN (this path invokes the GEMM operations). In particular, when the input dimension of the activations tensor is larger or equal than a certain threshold (1024, in our case), we switch to a path that dequantizes the weights into the full (16 bit) precision and invokes the PyTorch-based GEMM kernel. As shown in FIG. 7, the overhead of dequantization relative to the latency of the GEMM operation decreases as the size of the activations tensor grows.

A practical consequence s that one needs to pay attention to the input dimension of the activations tensor during inference. Specifically, by default, vLLM slices the given prompt into chunks of a certain size (512 tokens in v0.6.4, changed later to 2048 tokens in v0.7.0). As FIG. 7 shows, inputs of 512 tokens lead to nearly the worst slowdown for Marlin kernels over the baseline GEMM implementation. As a result, a prompt chunk size, controlled by the max_num_batched_tokens parameter in vLLM, may be set to 16K in all latency experiments described below.

Generation performance of several Llama models may be evaluated in baseline configurations as well as when quantized using RTN (with various levels of precision) and using GPTQ and AWQ. Two different setups—one with a short prompt of 256 tokens and output length of 32 tokens, and another with a long prompt of 4096 tokens and output length of 512 tokens—may be used. The first setup represents a short question-answer interaction with a chatbot, while the other represents a query with more context, such as one that might be generated by a code completion system. Since the results were similar for both setups, we include only figures for the first setup, for brevity. For all experiments, the built-in vLLM latency benchmark5 is used and all variants are run using the same hardware (1/4/8 H100 GPUs for Llama-3.1 8B/70B/405B models, respectively). Since the baseline Llama-3.1 405B model does not fit into 8 H100 GPUs, results are not included for this configuration.

The generation throughput results are shown in FIG. 6. For small batches, RTN-8 outperforms the baseline by up to 25%, while RTN-\tilde{4} outperforms the baseline by up to 37%. Note that RTN-\tilde{4} also outperforms GPTQ and AWQ on small batches despite that all three methods employ Marlin-based kernels and 4 bit precision. This advantage of RTN may be due to its relative simplicity that, among other things, does not consider zero points for its quantization groups (unlike both GPTQ and AWQ), hence requiring less floating point operations for dequantization. As expected, the performance of RTN-\tilde{6} and RTN-\tilde{5} falls in between RTN-8 and RTN-\tilde{4}. For large batches, RTN variants trail closely the baseline thanks to its dual-path approach discussed above. Marlin-based kernels for AWQ and GPTQ do not utilize this approach and hence perform poorly in this case.

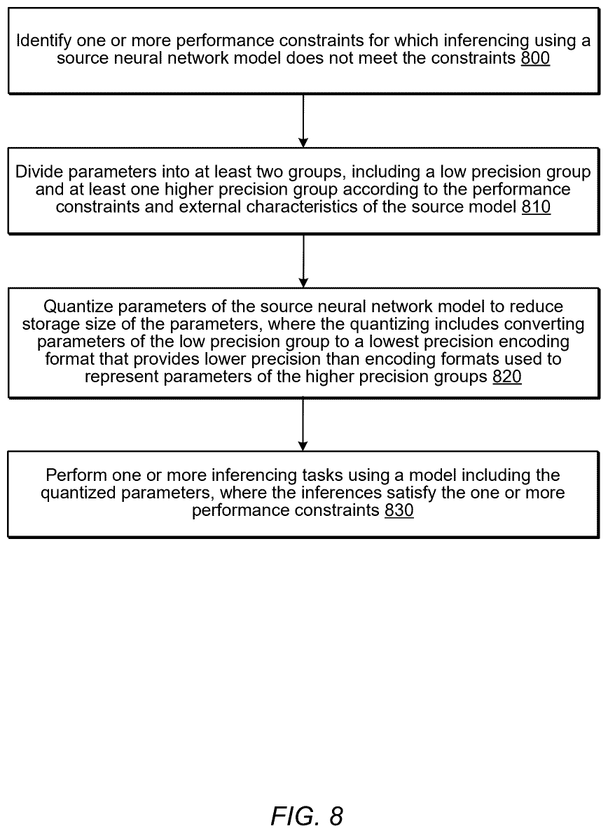

FIG. 8 is a flowchart illustrating a method for implementing a resource-optimized inferencing through selective quantization, according to at least one embodiment. In at least one embodiment, the process may begin at 800 where one or more performance constraints, such as performance criteria 130 of FIG. 1, may be identified of which inferencing of a source neural network model, such as such as source model 140 of FIG. 1 or large language model 200 of FIG. 2, does not satisfy. Examples of such constraints may include, in various embodiments, memory constraints, maximum latency constraints, processing constraints, accuracy constraints and so forth. These examples of constraints, however, are not intended to be limiting and other constraints may be envisioned.

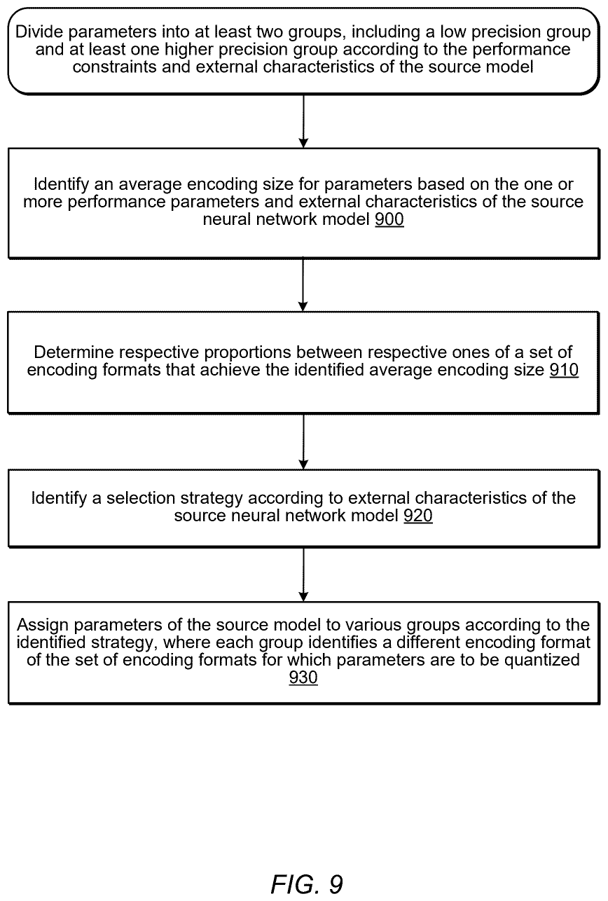

Then, as shown in 810, in at least one embodiment parameters of the source neural network model may be divided or assigned into at least two groups, including a low precision group and at least one higher precision group according to the performance constraints and external characteristics of the source model, such as external characteristics 144 of FIG. 1. This process is discussed in further detail below in FIG. 9. This selecting may be performed by a resource optimizer such as network optimizer 110 of FIG. 1. In at least one embodiment, two quantization dimensions may be considered. First, a portion of all model layers may be selected, with all their associated weights preserved at a higher precision. Second, each model layer often implements a similar architecture and consists of linear modules that contain weight parameters. Each of these modules across some or all model layers may be selected for preservation. In at least one embodiment, a mixture of selection techniques may be employed. To perform selection, a resource optimizer may be using configuration data, such as configuration data 112 of FIG. 1, in combination with the performance constraints. In various embodiments, configuration data may be generated in various ways, in some embodiments it may be specified along with the source model itself or derived from a type of source model while in other embodiments configuration data may be generated through benchmarking or other metrics derived from testing of source model 40 to calculate perplexity on a given set of data and choose a regime that leads to the lowest perplexity.

Then, as shown in 820, in at least one embodiment parameters of the large language model may be quantized to reduce storage size of the parameters, where the quantizing includes converting parameters of the low precision group to a low precision encoding format that provides lower precision than encoding formats used to represent parameters of the higher precision groups. During quantization, selected parameters are encoded for higher computational precision that unselected parameters such that encoding formats of unselected parameters provide lower precision than at least some encoding formats of selected parameters. In at least one embodiment, all parameters of a large language model may be quantized, where target encoding formats of selected parameters provide higher computational precisions than other encoding formats of unselected parameters. In at least one embodiments, at least a portion of selected parameters are preserved in one or more higher precision formats while unselected parameters are quantized to one or more lower precision formats. These are merely examples of quantization techniques and other techniques may be envisioned. Furthermore, quantization may employ a variety of quantization methods such as Round-to-nearest (RTN) quantization or other linear quantization methods, although these are merely examples and other quantization methods may be envisioned, and in at least one embodiment, quantization may generate encodings in numeric formats of a fixed size, such as four bits, eight bits, sixteen bits and so forth, and use data-free quantization methods that eliminate a need for separate calibration steps.

Then, as shown in 830, in at least one embodiment, one or more inferencing tasks, such as inferencing tasks 160 of FIG. 1, may be performed using a neural network model, such as resource-optimized model 120, to generate results such as inferencing results 170 of FIG. 1. The inferencing results may be produced by the resource-optimized model while satisfying the one or more performance constraints.

FIG. 9 is a flowchart illustrating a method for dividing parameters into encoding groups, according to at least one embodiment. The process begins at 900 where an average encoding size for parameters may be determined according to provided performance parameters, such as performance criteria 130 of FIG. 12, and external characteristics of a source neural network, such as external characteristics 144 of FIG. 1. For example, performance parameters may directly or indirectly indicate a total high speed memory size provided by neural network processors of an execution environment for an inferencing network. In various embodiments, the performance parameters may indicate an amount of memory directly or may indicate an available processing capability or maximum inferencing latency from which memory size may be determined. These are merely examples of performance parameters that may indicate an amount of memory available for inferencing and other performance parameters or methods of determining an amount of memory available may be envisioned.

External characteristics may then be used to determine an average encoding sized that may satisfy the determined memory size. For example, in at least one embodiment an external characteristic may define an amount of memory required to support a particular encoding size while in another embodiment an external characteristic may define a total number of parameters of a source neural network. These are merely examples of external characteristics that may indicate memory requirement for the source neural network and other external characteristic or methods of determining memory requirements may be envisioned. Through a simple computation, an average bit size for encoding parameters may be determined. It should be understood that while encoding formats include encodings of particular bit sizes such as four bit, eight bit or sixteen bit, an average encoding size may not conform to a single encoding format but may instead be satisfied by ratios of multiple encoding formats, in various embodiments.

As shown in 910, the determined average encoding size may be used to determine respective proportions of two or more encoding formats. For example, an average encoding size of six bits per parameter may be satisfied by quantizing a low precision group at a four bit encoding size and a higher precision group at an eight bit size. In this example, parameters of the model may be evenly divided between the low and high precision groups. In another example an average encoding size of six bits per parameter may be satisfied by quantizing a low precision group at a four bit encoding size and a higher precision group at a sixteen bit size. In this example, three quarters of model parameters make assigned to the low precision group while a remaining quarter is assigned to a high precision group. In other embodiments, two or more higher precision groups may be employed in the same manner. In at least one embodiment, external characteristics may be used to identify various encoding formats available for quantizing in the execution environment of the inferencing model. It should be understood that these are merely examples of determining encoding formats and proportions and any number of methods for implementing these determinations may be envisioned.

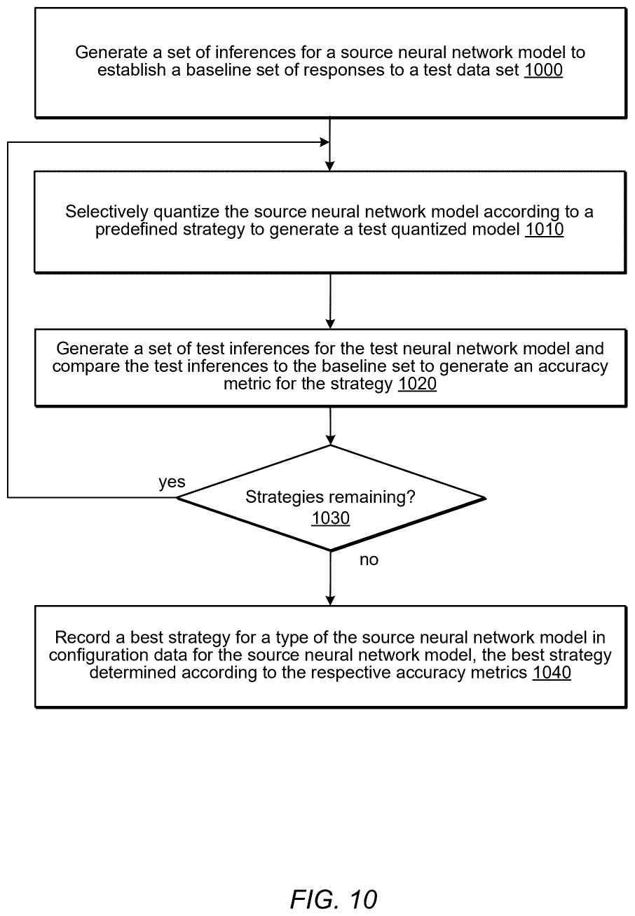

As shown in 920, a selection strategy may then be selected according to external characteristics of the source neural network model. For example, in at least one embodiment, a selection strategy may be selected based on a type of neural network model indicated by an external characteristic by accessing configuration data, such as configuration data 112 of FIG. 1, for the model type. This configuration data may be generated as described below in FIG. 10. In at least one embodiment, two quantization techniques, or a combination thereof, may be considered. First, a portion of all model layers may be selected, with all their associated parameters to be encoded at a higher precision. Second, for models similar to those shown in FIG. 2, each model layer may implement a similar architecture consisting of linear modules that contain weight parameters. Each of these modules across some or all model layers may be encoded at higher precision. In at least one embodiment, a mixture of these selection techniques may be employed.

Then as shown in 930, parameters of the source neural network model may be assigned to various groups according to the identified strategy, where each of the various groups identifies a different encoding format of the set of encoding formats for which the parameters of the group are to be quantized.

FIG. 10 is a flowchart illustrating a method for predetermining a preferring selection strategy for selective neural network quantization, according to at least one embodiment. In various embodiments, configuration data, such as configuration data 112 of FIG. 1, may be generated for neural network models, such a source model 140 of FIG. 1, in various ways, in some embodiments it may be specified along with the source model itself or derived from a type of source model while in other embodiments configuration data may be generated through benchmarking or other metrics derived from testing of a source neural model. While such testing may consume processing resources, unlike quantization calibration processes, this benchmarking may be performed only once in at least one embodiment and the results reused in the event of further training or fine-tuning of the source model, such as by training system 150 of FIG. 1.

As shown in 1000, a set of baseline inferences may be generated for a source neural network model for a test data set. Then as shown in 1010, the source neural network may be selectively quantized according to a particular predefined strategy to generate a test quantized model. In at least one embodiment, this predefined strategy may employ a horizontal selection technique or a vertical selection technique, as discussed above in FIGS. 2-4, or a combination thereof. Additionally, the predefined strategy may select from a first number of layers, a middle number of layers or a last number of layers or a combination thereof. It should be understood that these predefined strategies are merely examples and any number of predefined strategies may be envisioned.

Then, as shown in 1020, a set of test inferences for the test neural network model may be generated and compared for accuracy to the baseline set. This comparison may be used, in at least one embodiment, to generate and accuracy metric for the test neural network model.

Then, if additional predefined strategies remain, as shown in a positive existing from 1030, the process may return to 1010. If no predefined strategies remain, as shown in a negative existing from 1030, the process may advance to 1040 where a best strategy may be determined and recorded in configuration data, such as configuration data 112 of FIG. 1, according to the respective accuracy metrics. In at least one embodiment, the best strategy may be associated with a neural network type of the source neural network model as determined by external characteristics, such as external characteristics 144 of FIG. 1, and subsequently used to determine a selective quantization strategy for the source neural network model and other neural network models of a same neural network type.

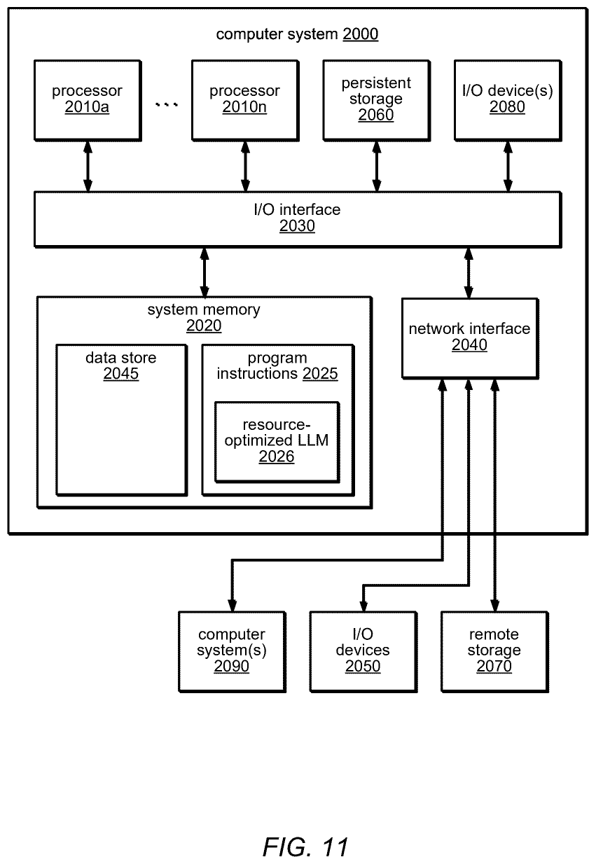

Various ones of the illustrated embodiments may include one or more computer systems 2000 such as that illustrated in FIG. 11 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for optimizing resource usage in an LLM as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 11 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A system, comprising:
one or more processors and a memory, the memory comprising program instructions executable by the one or more processors to implement a resource-optimized neural network (NN) configured to:
assign parameters of a plurality of parameters of a source NN to respective groups of parameters, including a low precision group and at least one high precision group, according to a resource constraint and one or more metrics, the one or more metrics comprising at least one or more external characteristics of the source NN;
quantize, individual parameters of the low precision group using a low precision encoding format, the low precision encoding format providing lower precision than one or more higher precision formats used to encode individual parameters of the one or more high precision groups; and
perform one or more inferencing tasks, the performing satisfying the resource constraint.

2. The system of claim 1, wherein the resource constraint is based at least in part on one or more of a memory constraint, a latency constraint and an accuracy constraint.

3. The system of claim 1, wherein the quantizing is performed according to a round-to-nearest (RTN) quantizing technique.

4. The system of claim 1, wherein the external characteristics of the source NN comprise one more of a model type, a number of parameters of the neural network, one or more hyperparameters used for training, data set used for training, an amount of memory available for inferencing and an amount of processing available for inferencing.

5. The system of claim 1, wherein the quantizing is performed as part of loading of respective parameters of the NN to generate the resource-optimized NN.

6. The system of claim 1, wherein the assigning comprises:
identifying respective subsets of a plurality of linear modules in individual ones of one or more layers of the neural network according to a metric of model accuracy; and
assigning individual parameters of the identified subsets to the at least one high precision group.

7. The system of claim 1, the resource-optimized NN further configured to:
fine-tune the source NN to generate a fine-tuned NN comprising respective fine-tuned parameters; and
quantize the fine-tuned parameters to generate a fine-tuned resource-optimized neural network, the quantizing performed according to the respective assignments of corresponding parameters to the parameter groups, wherein the quantizing is performed according to a linear quantizing technique without calibration of fine-tuned parameters.

8. A method, comprising:
assigning parameters of a plurality of parameters of a neural network to respective groups of parameters, including a low precision group and at least one high precision group, according to a resource constraint and one or more metrics, the one or more metrics comprising at least one or more external characteristics of the neural network;
quantizing, to generate a resource-optimized neural network, individual parameters of the low precision group using a low precision encoding format, the low precision encoding format providing lower precision than one or more higher precision formats used to encode individual parameters of the one or more high precision groups; and
performing one or more inferencing tasks using the resource-optimized neural network, the performing satisfying the resource constraint.

9. The method of claim 8, wherein the one or more metrics exclude internal characteristics of the neural network.

10. The method of claim 8, wherein the resource constraint is based at least in part on one or more of a memory constraint, a latency constraint and an accuracy constraint.

11. The method of claim 8, wherein the quantizing is performed according to a round-to-nearest (RTN) quantizing technique.

12. The method of claim 8, wherein the quantizing is performed as part of loading of respective parameters of the neural network to generate the resource-optimized neural network.

13. The method of claim 8, wherein the external characteristics of the neural network comprise one more of a model type, a number of parameters of the neural network, one or more hyperparameters used for training, data set used for training, an amount of memory available for inferencing and an amount of processing available for inferencing.

14. The method of claim 8, wherein the assigning comprises assigning individual parameters of one or more layers of the neural network to the at least one high precision group according to a metric of model accuracy.

15. The method of claim 8, wherein the assigning comprises:
identifying respective subsets of a plurality of linear modules in individual ones of one or more layers of the neural network according to a metric of model accuracy; and
assigning individual parameters of the identified subsets to the at least one high precision group.

16. The method of claim 8, further comprising:
fine-tuning the neural network to generate a fine-tuned neural network comprising respective fine-tuned parameters; and
quantizing the fine-tuned parameters to generate a fine-tuned resource-optimized neural network, the quantizing performed according to the respective assignments of corresponding parameters to the parameter groups, wherein the quantizing is performed according to a linear quantizing technique without calibration of fine-tuned parameters.

17. One or more non-transitory computer-accessible storage media storing program instructions that when executed on or across one or more processors cause the one or more processors to implement a resource-optimized neural network, comprising:
assigning parameters of a plurality of parameters of a source neural network to respective groups of parameters, including a low precision group and at least one high precision group, according to a resource constraint and one or more metrics, the one or more metrics comprising at least one or more external characteristics of the source neural network;
quantizing individual parameters of the low precision group using a low precision encoding format, the low precision encoding format providing lower precision than one or more higher precision formats used to encode individual parameters of the one or more high precision groups; and
performing one or more inferencing tasks, the performing satisfying the resource constraint.

18. The one or more non-transitory computer-accessible storage media of claim 17, wherein the resource constraint is based at least in part on one or more of a memory constraint, a latency constraint and an accuracy constraint.

19. The one or more non-transitory computer-accessible storage media of claim 17, wherein the quantizing is performed according to a round-to-nearest (RTN) quantizing technique.

20. The one or more non-transitory computer-accessible storage media of claim 17, wherein the external characteristics of the neural network comprise one more of a model type, a number of parameters of the neural network, one or more hyperparameters used for training, data set used for training, an amount of memory available for inferencing and an amount of processing available for inferencing.
